(19) United States
(12) Patent Application Publication
(10) Pub. No.: US 2026/0237585 A1
(43) Pub. Date: Aug. 13, 2026

(54) OPTIMIZED BATTERY DISCONNECT UNIT

(71) Applicant: SENSATA TECHNOLOGIES, INC., ATTLEBORO, MA (US)

(72) Inventors: KAMEN HRISTOV RUSEV, SOFIA (BG); VALENTIN GRIGOROV GRIGOROV, SOFIA (BG); MATTHEW J. DUBE, WESTBOROUGH, MA (US); LAURENS C. FORTGENS, ODIJK (NL)

(21) Appl. No.: 19/152,431

(22) PCT Filed: Feb. 1, 2024
(86) PCT No.: PCT/US2024/014068

§ 371 Date: Jul. 30, 2025

Related U.S. Application Data
(60) Provisional application No. 63/482,839, filed on Feb. 2, 2023.

(51) Int. Cl. H01H 85/055; H01H 69/02; H01H 85/02; H01H 85/143; H01H 85/165; H01M 50/583

(52) U.S. Cl. CPC H01H 85/055; H01H 69/02; H01H 85/143; H01H 85/165; H01M 50/583; H01H 2085/025; H01M 2200/103

(57) ABSTRACT

Apparatuses and methods for an optimized battery disconnect unit are disclosed. In a particular embodiment, a battery disconnect unit includes a housing; a configuration contactor disposed within the housing; a combined contactor and pyrofuse assembly disposed within the housing and electrically coupled to the configuration contactor; a battery charge contactor disposed within the housing and electrically coupled to the combined contactor and pyrofuse assembly; and a bus bar assembly. In some examples, the bus bar assembly is tiered.

### BACKGROUND

Electromechanical switching devices, such as contactors and relays, are designed to carry a certain amount of electrical current for certain periods of time. Such devices are particularly important in electric vehicles. Typically, electric vehicles have a battery management system that includes a battery disconnect unit (BDU). The BDU is the primary interface between the battery pack and the electrical system. The BDU includes electromechanical switches that open or close high current paths between the battery pack and the electrical system. A BDU may be a large, complex, and expensive component of the electric vehicle. In some designs, the BDU may be prone to overheating.

### SUMMARY

Apparatuses and methods for optimized battery disconnect units are disclosed. In various embodiments, the size and complexity of a battery disconnect unit (BDU) is reduced by packaging a configuration contactor, a dual combined contactor and pyrofuse assembly, and a dual fast charge contactor in a single housing. In other embodiments, the size and complexity of a BDU is reduced by packaging a configuration contactor, a pyrofuse, a dual main contactor, a dual fast charge contactor, and a dual utility contactor in a single housing. Tiered bus bars are utilized to increase power density while also providing a common interface for a cooling plate, thus enhancing the cooling capabilities of the BDU. The integrated system also provides electrical isolation from dynamic conditions as well as increased performance at high loads. The complexity of the assembling process is also reduced.

A particular embodiment is directed to a battery disconnect unit including a housing; a configuration contactor disposed within the housing; a combined contactor and pyrofuse assembly disposed within the housing and electrically coupled to the configuration contactor; a battery charge contactor disposed within the housing and electrically coupled to the combined contactor and pyrofuse assembly; and a bus bar assembly. In some examples, the bus bar assembly is tiered. In some examples, the bus bar assembly includes terminals in one or more planes. In some examples at least two terminals are stacked. In various examples, the bus bar assembly includes a plurality of bus bars each having a surface exposed through a bottom of the housing. In these examples, the battery disconnect unit is configurable for mounting on a cooling plate. In some examples, one or more battery sensors are disposed within the housing.

Another embodiment is directed to a method of assembling a battery disconnect unit. The method includes providing a bus bar assembly in a base of a housing; coupling a configuration contactor, a dual combined contactor and pyrofuse assembly, and a dual fast charge contactor to the bus bar assembly; and placing a cover of the housing over the configuration contactor, the dual combined contactor and pyrofuse assembly, and the dual fast charge contactor.

Yet another embodiment is directed to battery disconnect unit including a housing; a configuration contactor disposed within the housing; a pyrofuse disposed within the housing and electrically coupled to the configuration contactor; a dual main contactor disposed within the housing and electrically coupled to the pyrofuse; a dual fast charge contactor disposed within the housing and electrically coupled to the to the dual main contactor; a dual utility contactor; and a bus bar assembly coupled to the configuration contactor, pyrofuse, dual main contactor, dual fast charge contactor, and dual utility contactor. In some examples, the battery disconnect unit further includes a thermally conductive pad disposed on a bottom surface of the housing. In some examples, the bus bar assembly includes a plurality of bus bars each having a surface exposed through a bottom surface of the housing. In some examples, the battery disconnect unit further includes one or more battery sensors.

Yet another embodiment is directed to a method of assembling a battery disconnect unit. The method includes providing a bus bar assembly in a base of a housing; coupling a configuration contactor, a pyrofuse, a dual main contactor, a dual fast charge contactor, and a dual utility contactor to the bus bar assembly; and placing a cover of the housing over the configuration contactor, pyrofuse, dual main contactor, dual fast charge contactor, and dual utility contactor. In some examples, the method further includes placing a thermally conductive pad on a bottom surface of the housing. In some examples, the bus bar assembly includes a plurality of bus bars each having a surface exposed through a bottom surface of the housing. In some examples, the method further includes installing one or more battery sensors.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a diagram of an example battery disconnect unit in accordance with at least one embodiment of the present disclosure.

FIG. 2 is a diagram of an example bus bar assembly according to the battery disconnect unit of FIG. 1, in accordance with at least one embodiment of the present disclosure.

FIG. 3 is a diagram of an example housing base according to the battery disconnect unit of FIG. 1, in accordance with at least one embodiment of the present disclosure.

FIG. 4 is a diagram of the bus bar assembly of FIG. 2 installed in the housing base of FIG. 3, in accordance with at least one embodiment of the present disclosure.

FIG. 5 is a diagram of the example battery disconnect unit of FIG. 1 partially assembled in accordance with at least one embodiment of the present disclosure.

FIG. 6 is another diagram of the example battery disconnect unit of FIG. 1 partially assembled in accordance with at least one embodiment of the present disclosure.

FIG. 7 is a diagram of the example battery disconnect unit of FIG. 1 fully assembled in accordance with at least one embodiment of the present disclosure.

FIG. 8 is a view of the bottom of the example battery disconnect unit of FIG. 1 in accordance with at least one embodiment of the present disclosure.

FIG. 9 is an example electrical schematic for the example battery disconnect unit of FIG. 1 in accordance with at least one embodiment of the present disclosure.

FIG. 10 is an example terminal specification for the example battery disconnect unit of FIG. 1 in accordance with at least one embodiment of the present disclosure.

FIG. 11 is a flowchart of an example method of assembling an example battery disconnect unit according to at least one embodiment of the present disclosure.

FIG. 12A is an exploded view of another example battery disconnect unit according to at least one embodiment of the present disclosure.

FIG. 12B is another exploded view of the battery disconnect unit of FIG. 12A.

FIG. 13 is a perspective bottom view of the example battery disconnect unit of FIGS. 12A and 12B according to at least one embodiment of the present disclosure.

FIG. 14 is an overhead view of the example battery disconnect unit of FIGS. 12A and 12B according to at least one embodiment of the present disclosure.

FIG. 15 is a perspective view of the example battery disconnect unit of FIGS. 12A and 12B according to at least one embodiment of the present disclosure.

FIG. 16 is bottom view of the example battery disconnect unit of FIGS. 12A and 12B according to at least one embodiment of the present disclosure.

FIG. 17 is another perspective view of the example battery disconnect unit of FIGS. 12A and 12B according to at least one embodiment of the present disclosure.

FIG. 18 is another perspective view of the example battery disconnect unit of FIGS. 12A and 12B according to at least one embodiment of the present disclosure.

FIG. 19 is a front view of the example battery disconnect unit of FIGS. 12A and 12B according to at least one embodiment of the present disclosure.

FIG. 20 is a side view of the example battery disconnect unit of FIGS. 12A and 12B according to at least one embodiment of the present disclosure.

FIG. 21 is an example terminal specification for the example battery disconnect unit of FIGS. 12A and 12B according to at least one embodiment of the present disclosure.

FIG. 22 an example electrical schematic for the example battery disconnect unit of FIGS. 12A and 12B according to at least one embodiment of the present disclosure.

FIG. 23 is a flowchart of another example method of assembling an example battery disconnect unit according to at least one embodiment of the present disclosure.

FIG. 24 is an example electrical schematic of an assembly that includes an example battery disconnect unit according to at least one embodiment of the present disclosure.

FIG. 25A is an exploded view of another example battery disconnect unit according to at least one embodiment of the present disclosure.

FIG. 25B is an overhead view of an assembly of some of the components from the example battery disconnect unit of FIG. 25A according to at least one embodiment of the present disclosure.

FIG. 25C is a perspective view of an assembly of some of the components from the example battery disconnect unit of FIG. 25A and the assembly of FIG. 25B according to at least one embodiment of the present disclosure.

FIG. 26 is an example simplified electrical schematic of an assembly of some of the components from the example battery disconnect unit of FIG. 25A and the assembly of FIG. 25B.

### DETAILED DESCRIPTION

The terminology used herein for the purpose of describing particular examples is not intended to be limiting for further examples. Whenever a singular form such as “a”, “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises”, “comprising”, “includes” and/or “including”, when used, specify the presence of the stated features, integers, steps, operations, processes, acts, elements and/or components, but do not preclude the presence or addition of one or more other features, integers, steps, operations, processes, acts, elements, components and/or any group thereof.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e., only A, only B, as well as A and B. An alternative wording for the same combinations is “at least one of A and B”. The same applies for combinations of more than two elements.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

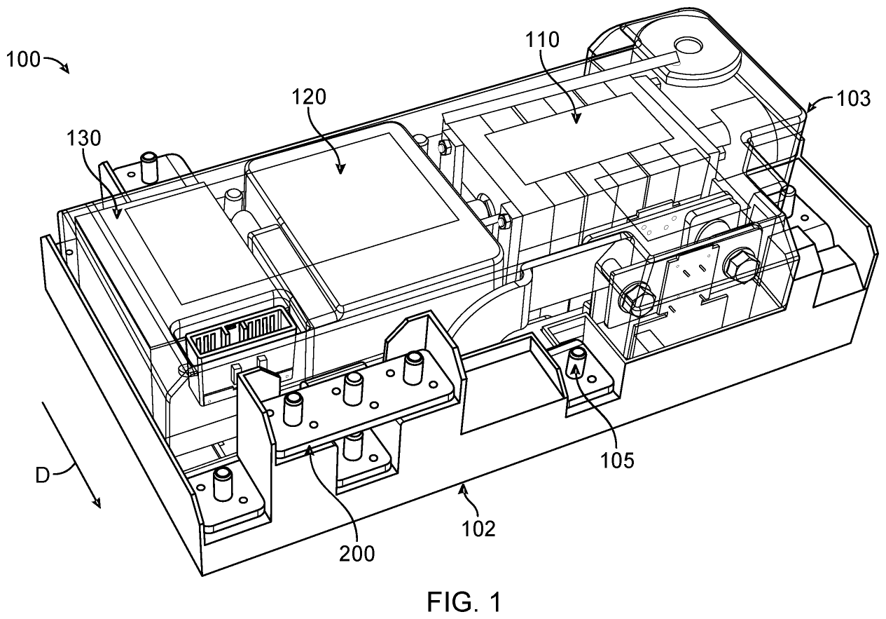

A description of the embodiments begins with FIG. 1. FIG. 1 sets forth a diagram of an example battery disconnect unit (BDU) 100 in accordance with at least one embodiment of the present disclosure. The example BDU 100 includes a housing formed by a housing base 102 and a housing cover 103 (shown as semitransparent for clarity). The housing integrates a configuration contactor 110, a dual combined contactor and pyrofuse assembly 120, and a dual fast charge contactor 130. A bus bar assembly 200 includes contact plates for connecting the configuration contactor 110, the dual combined contactor and pyrofuse assembly 120, and the dual fast charge contactor 130, as well as terminals 105 for interfacing with external components. The bus bar assembly 200, and thus the terminals 105, are tiered such that different terminals may exist in different horizontal planes of the BDU 100. In some examples, the terminals 105 may be stacked in different planes. In FIG. 1 and the following figures, a direction D represents a reference side and orientation of the BDU.

In the example of FIG. 1, the example BDU 100 includes one configuration contactor, one dual combined contactor and pyrofuse assembly, one dual fast charge contactor, and two battery current sensors in an orientation optimized to fit these components. In the example BDU 100, shared contactors/combined contactor and pyrofuse assembly and a box housing minimizes the height/length/width of the BDU and maximizes power density. An optimized bus bar layout enables maximum power density, and bus bars are section configurable to the meet needs of different cooling strategies. In the example BDU 100, bus bars share a surface in one plane for mounting on cooling plate via electric insulating pads. The bus bars are sunk in the bottom of the housing to allow one-plane interface between cooling pads and cooling plate. The example BDU 100 includes a dedicated bus bar slot for maximum possible creepage for clearance and electrical insulating performance. Limited and configurable mounting points enable reduced installation cost. The example BDU provides optimized thermal efficiency by including cooling pads between dual combined contactor and pyrofuse assembly and dual fast charge contactor. The complexity of BDU assembly process is reduced and simplified, and copper utilization is reduced because of the compact design

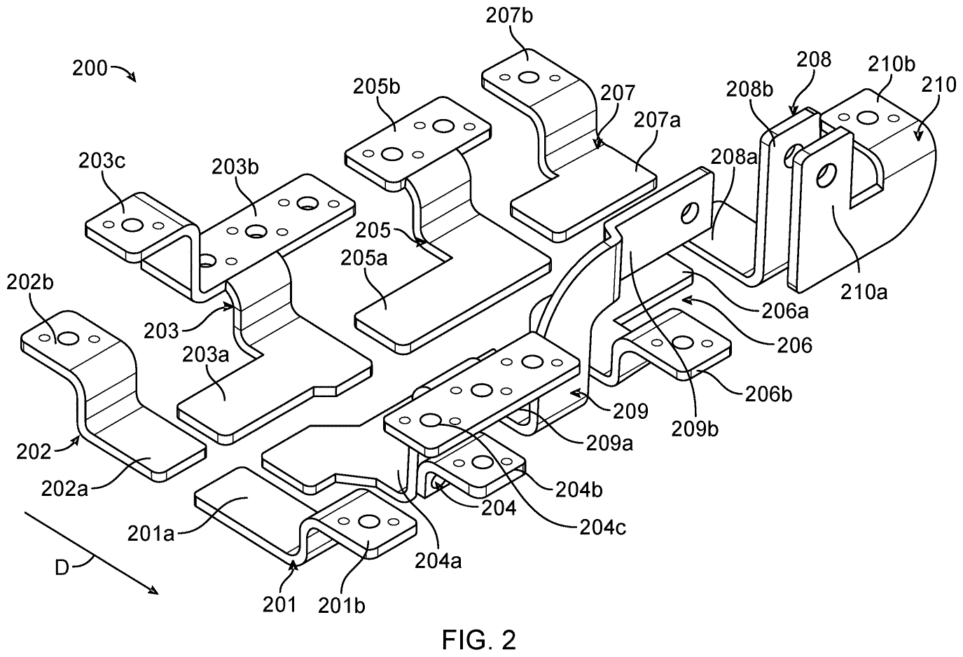

For further explanation, FIG. 2 sets forth a diagram of an example bus bar assembly 200 for the example BDU 100 in accordance with at least one embodiment of the present disclosure. The example bus bar assembly 200 includes bus bars 201, 202, 203, 204, 205, 206, 207, 208, 209, 210 having contact plates in different planes. For example, in the example bus bar assembly 200, bus bar 201 includes an internal component contact plate 201a (e.g., for interfacing with the fast charge contactor 130) in a first plane and an external component contact plate 201b in a different plane. Similarly, bus bar 202 includes an internal component contact plate 202a (e.g., for interfacing with the fast charge contactor 130) in a first plane and an external component contact plate 202b in a different plane.

In some examples, a bus bar includes external component contact plates in multiple planes. For example, bus bar 203 includes an internal component contact plate 203a (e.g., for interfacing with the fast charge contactor 130 and the combined contactor and pyrofuse assembly 120) in a first plane, an external component contact plate 203b in a second plane, and another external component contact plate 203c in a third plane. The external contact plates in multiple planes may also be stacked. For example, bus bar 204 includes an internal component contact plate 204a (e.g., for interfacing with the fast charge contactor 130 and the combined contactor and pyrofuse assembly 120) in a first plane, an external component contact plate 204b in a second plane, and another external component contact plate 203c in a third plane, where the external component contact plate 204b and the external component contact plate 204c are stacked.

In some examples, one contact plate is perpendicular to another contact plate. For example, bus bar 209 includes an internal component contact plate 209a (e.g., for interfacing with the combined contactor and pyrofuse assembly 120) and another internal component contact plate 209b (e.g., for interfacing with the configuration contactor 110) that is perpendicular to the contact plate 209a. Bus bar 208 includes an internal component contact plate 208a (e.g., for interfacing with the configuration contactor 110) and another contact plate 208b perpendicular to the contact plate 208a for interfacing with another bus bar 210.

The bus bar assembly 200 also includes bus bar 205 having an internal component contact plate 205a (e.g., for interfacing with the combined contactor and pyrofuse assembly 120 and the configuration contactor 110) in a first plane and an external component contact plate 205b in a second plane. Bus bar 206 includes an internal component contact plate 206a (e.g., for interfacing with the configuration contactor 110) in a first plane and an external component contact plate 206b in a second plane. Bus bar 207 includes an internal component contact plate 207a (e.g., for interfacing with the configuration contactor 110) in a first plane and an external component contact plate 207b in a second plane. The bus bar 210 includes a contact plate 210a for interfacing with bus bar 208 and an external component contact plate 210b.

In some examples, the internal component contact plates 201a, 202a, 203a, 204a, 205a, 206a, 207a, 208a, 209a are disposed within the same plane, such that these contact plates also serve as cooling pads on the bottom of the BDU 100 (on a surface opposite of the internal component interface), where the cooling pads interface with a cooling plate for cooling the BDU. In some examples, internal component contact plates 202b, 203b, 205b, 207b exist in the same plane. In some examples, internal component contact plates 201b, 204b, 206b, 208a, 209a exist in the same plane. In some examples, internal component contact plates 201b, 202b, 203b, 204b, 205b, 206b, 207b, 208b, 209b all exist in the same plane.

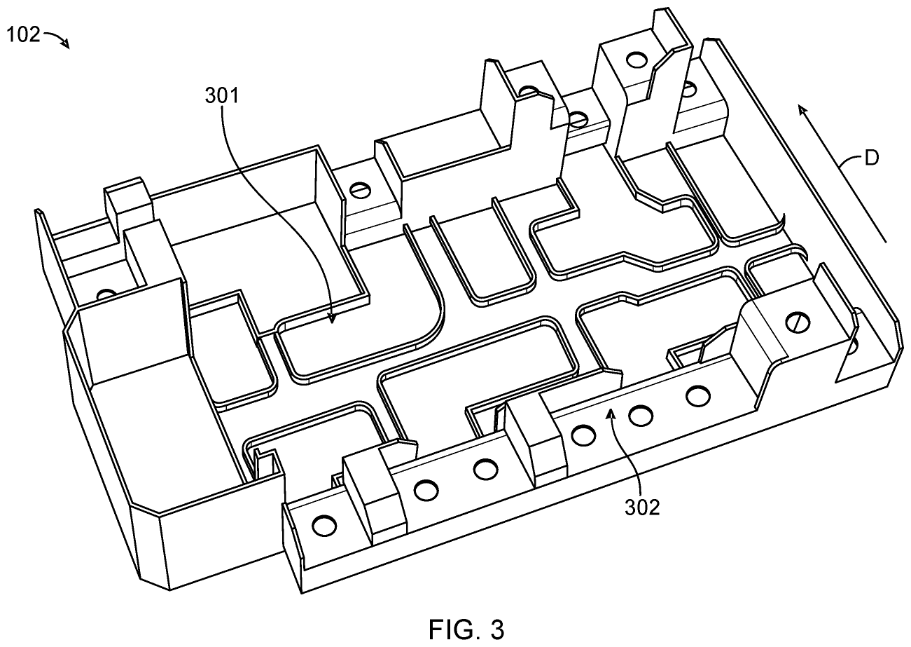

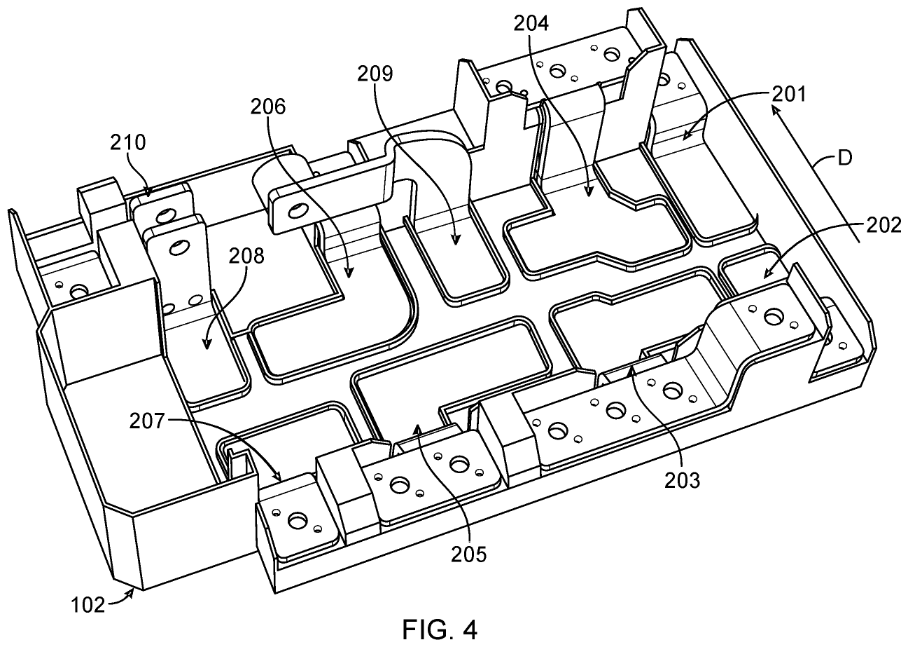

For further explanation, FIG. 3 sets forth a diagram of a housing base 102 for the example BDU 100 in accordance with at least one embodiment of the present disclosure. The housing base 102 includes respective apertures 301 for seating the internal component contact plates 201a, 202a, 203a, 204a, 205a, 206a, 207a, 208a, 209a. The internal contact plates are seated in the apertures such that the bottom surface of the internal contact plates (opposite the surface of the internal component interface) may interface with a cooling plate when the BDU 100 is mounted on a cooling plate (not shown). The housing base 102 also includes platforms 302 for supporting the external component contact plates described above. The platforms 302 may include apertures for terminals. For further explanation, FIG. 4 set forth a diagram illustrating the bus bar assembly 200 of FIG. 2 placed on the housing base 102 of FIG. 3. In FIG. 4, each bus bar 201, 202, 203, 204, 205, 206, 207, 208, 209, 210 is supported by a respective platform 302 (except for bus bars 208, 209), and each of these bus bars is seated within a respective aperture 301 (except for bus bar 210).

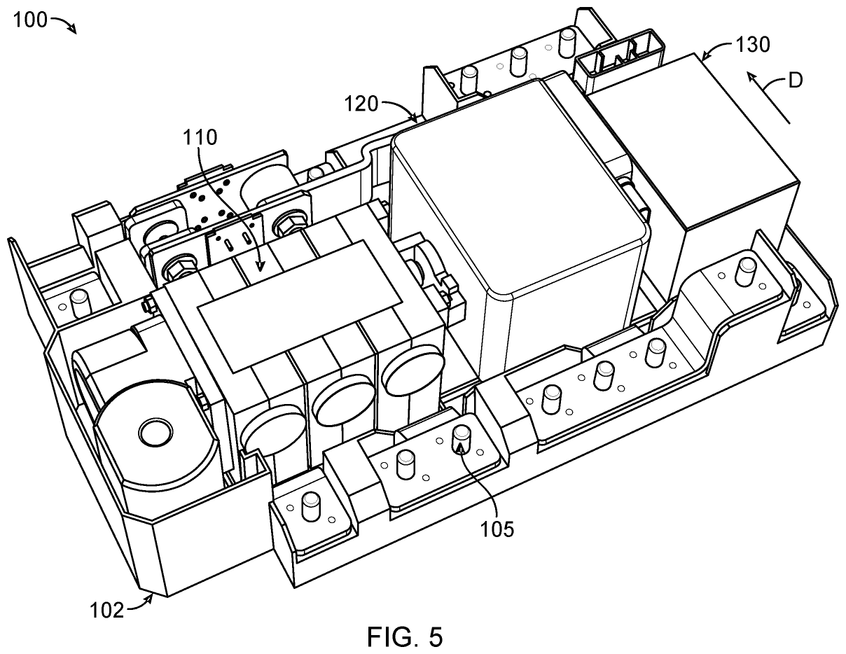

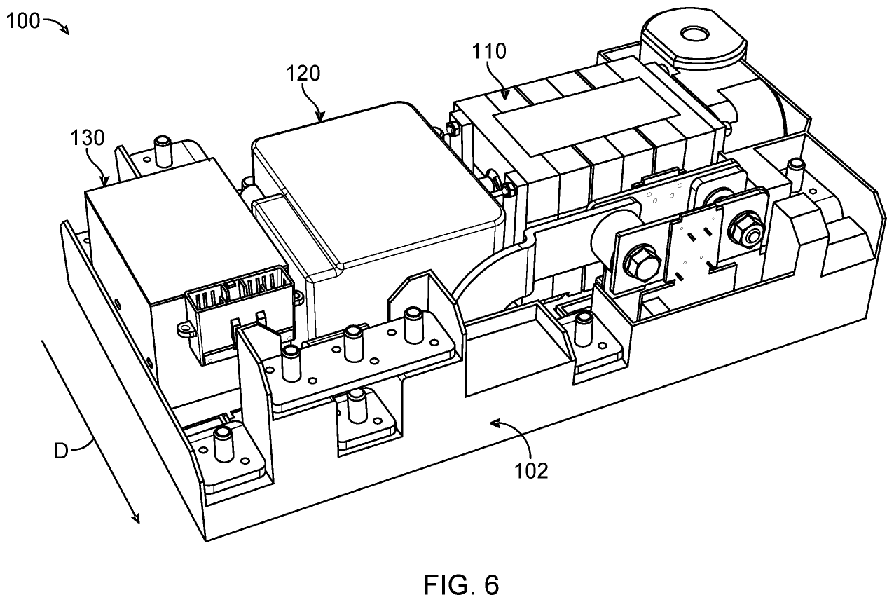

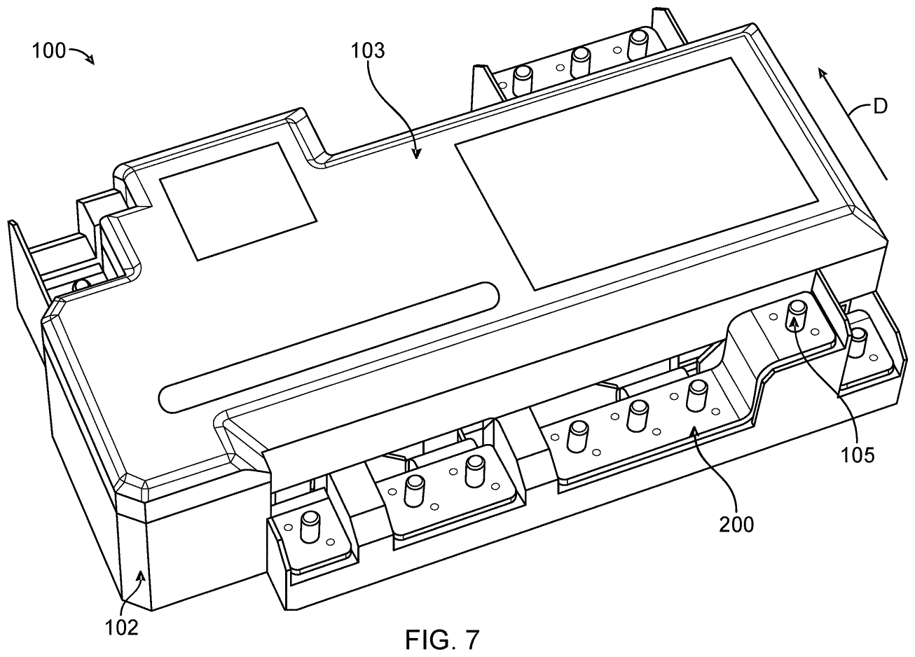

For further explanation, FIGS. 5, 6, and 7 set forth perspective views of the example BDU 100 in accordance with at least one embodiment of the present disclosure. In FIG. 5, with the housing cover 103 removed, it can be seen that the configuration contactor 110, the combined contactor and pyrofuse assembly 120, and the fast charge contactor 130 are placed on the bus bar assembly 200 within the housing base 102. The bus bars of the bus bar assembly 200 include terminals 105 for interfacing with external components. The terminals may be laser welded or bolted to the external component contact plates of the bus bar assembly. FIG. 6 is a view of the example BDU 100 from a direction opposite the view of FIG. 5. In the view of FIG. 7, the example BDU 100 is shown with the housing cover 103 assembled.

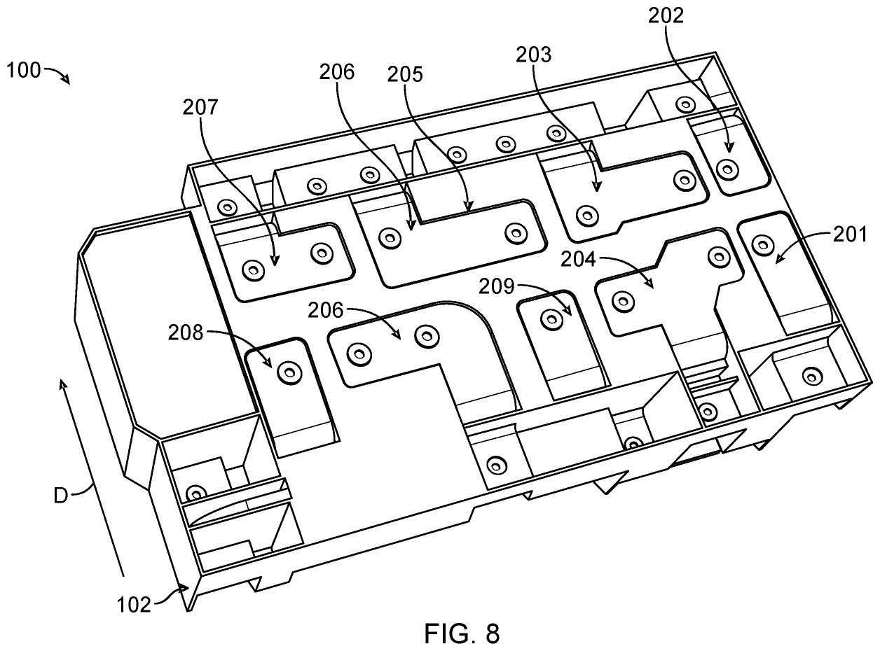

For further explanation, FIG. 8 sets forth a perspective bottom view of the example BDU 100 in accordance with at least one embodiment of the present disclosure. In the view of FIG. 8, it can be seen that the bottom surfaces of the bus bars 201, 202, 203, 204, 205, 206, 207, 208, 209 are cooling pads that provide a common surface for interfacing with a cooling plate (not shown). This enhances the cooling capabilities of the BDU 100.

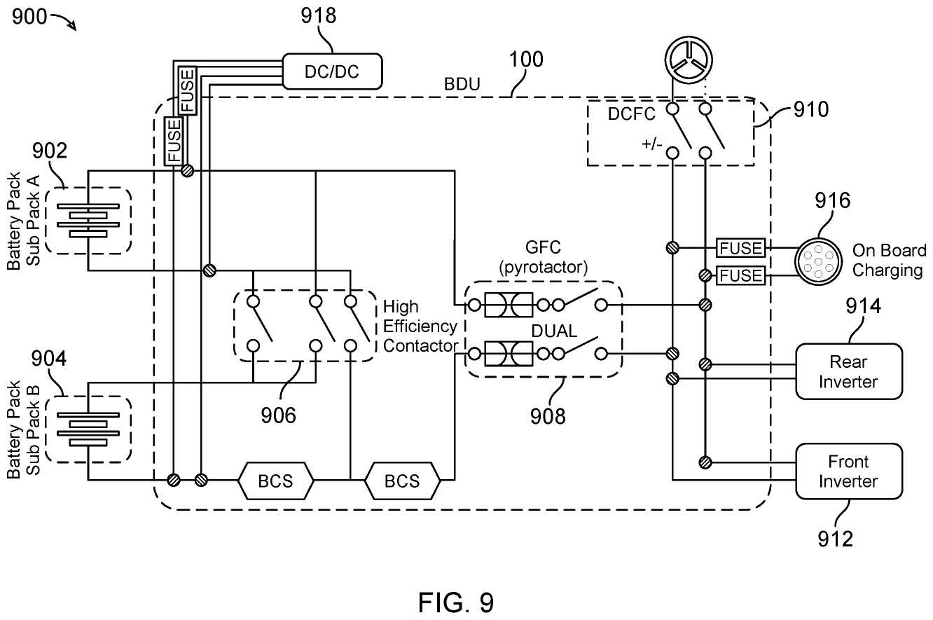

For further explanation, FIG. 9 sets forth an example electrical schematic 900 for the example BDU 100 in accordance with at least one embodiment of the present disclosure. The BDU 100 includes a dual configuration contactor 906, a dual combined contactor and pyrofuse assembly 908, and a dual fast charge contactor 910. The high efficiency configuration contactor 906 includes a positive battery switch, a negative battery switch, and a master switch connected to battery packs 902, 904 through respective circuits. Battery pack sensors battery charge sensors (BCS) also connected to the battery packs 902, 904. The configuration contactor 906 is connected to the dual combined contactor and pyrofuse assembly 908, which includes master contactors and a pyrofuse. The combined contactor and pyrofuse assembly 908 is connected to the dual fast charge contactor 910, which connects to on-board charging 916, a front inverter 912 (e.g., front wheel drive), a rear inverter 914 (e.g., for rear wheel drive), as well as fast charging terminals. The BDU 100 is also connected to a DC-DC converter 918.

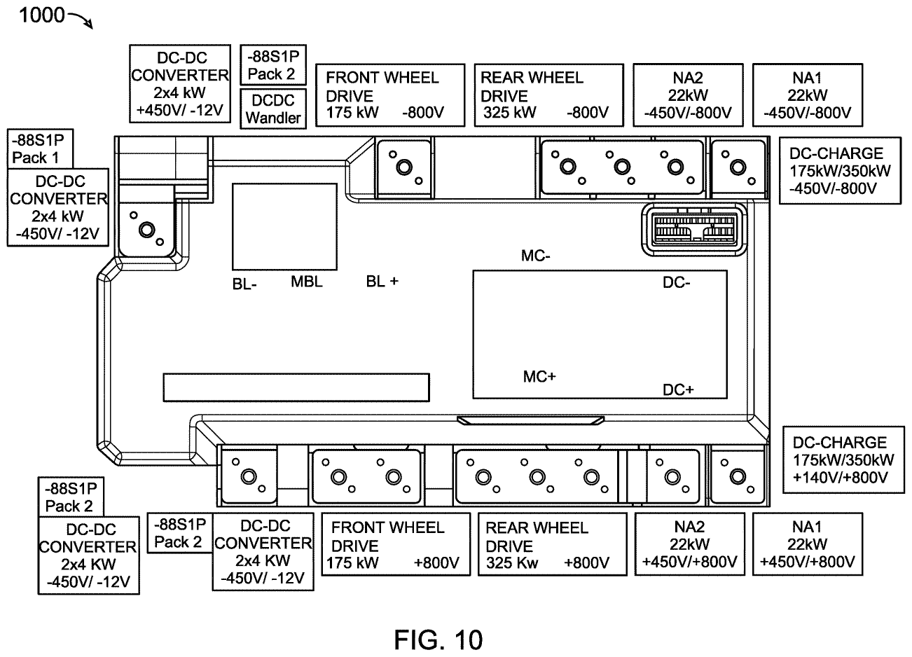

For further explanation, FIG. 10 sets forth an example terminal schematic 1000 for the example BDU 100 in accordance with at least one embodiment of the present disclosure.

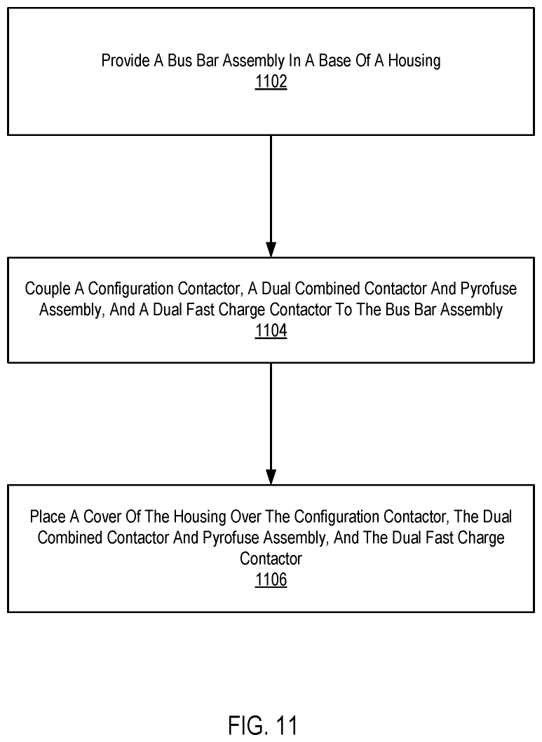

For further explanation, FIG. 11 sets forth a flowchart illustrating an example method of assembling a BDU in accordance with at least one embodiment of the present disclosure. The method of FIG. 11 includes providing 1102 a bus bar assembly in a base of a housing. For example, a bus bar assembly may be placed in a housing base as illustrated in FIGS. 2-4. The method of FIG. 11 also includes coupling 1104 a configuration contactor, a dual combined contactor and pyrofuse assembly, and a dual fast charge contactor to the bus bar assembly. For example, the configuration contactor, the dual combined contactor and pyrofuse assembly, and the dual fast charge contactor may be coupled to the bus bar assembly as shown in FIGS. 5 and 6. The method of FIG. 11 also includes placing 1106 a cover of the housing over the configuration contactor, the dual combined contactor and pyrofuse assembly, and the dual fast charge contactor. External component contact plates and terminals thereon may be left exposed when the cover is placed on the housing. In some examples, the external component contact plates may be tiered, such that contact plates and terminals exist on different planes of the BDU. In some examples, the external component contact plates may be stacked. In some examples of bottom surface of the base of the housing exposes internal component contact plates, such that the surfaces of these contact plates form cooling pads for interfacing with a cooling plate.

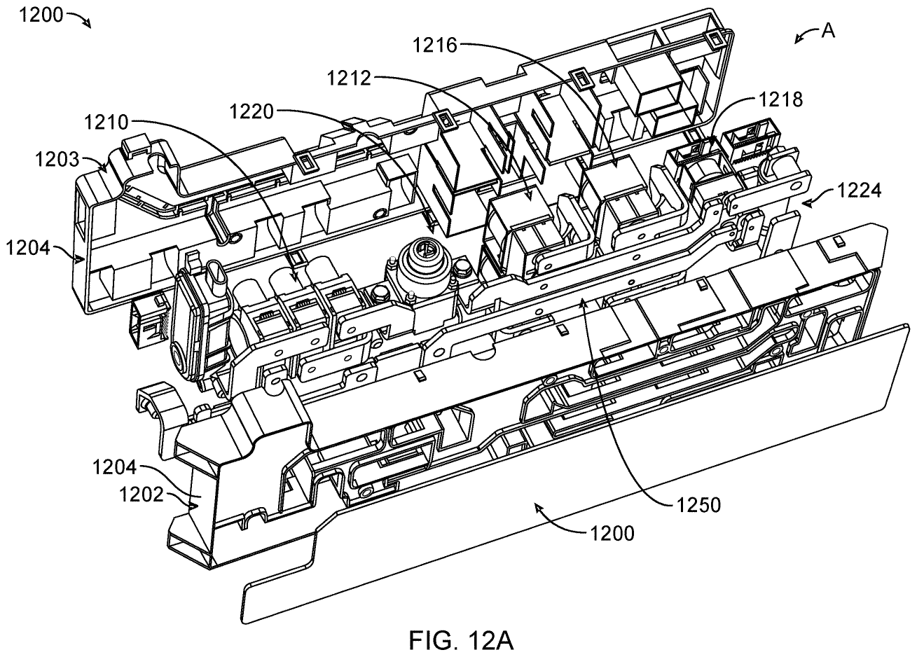

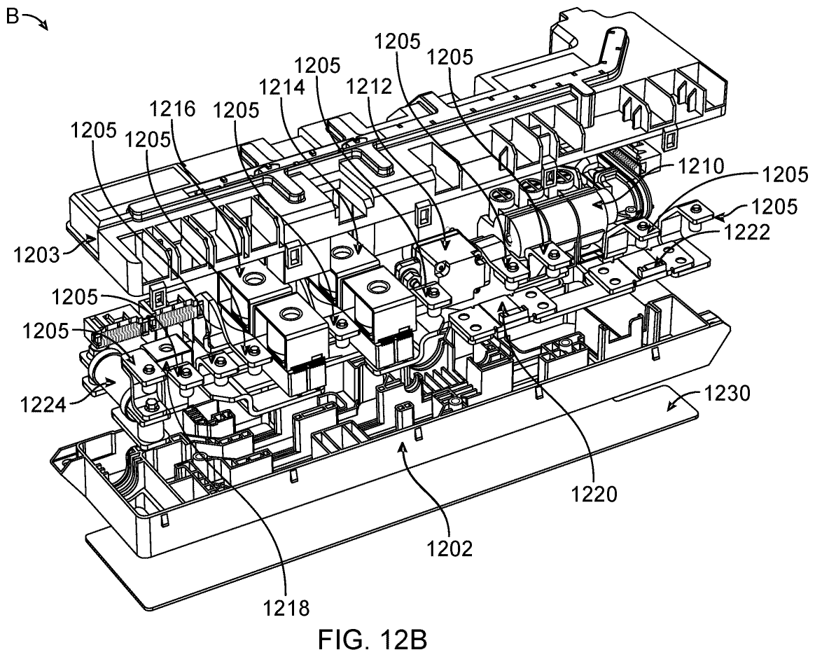

FIGS. 12A and 12B set forth exploded views of another example BDU 1200 in accordance with at least one embodiment of the present disclosure. FIGS. 12A and 12B illustrate different sides of the example BDU 1200. FIG. 12A shows side A (i.e., the port side) of the BDU 1200, whereas FIG. 12B shows side B (i.e., the terminal side). The example BDU 100 includes a housing 1204 formed by a housing base 1202 and a housing cover 1203. The housing integrates a configuration contactor 1210, dual main contactor 1214, pyrofuse 1212, dual fast charge contactor 1216, dual utility contactor 1218, auxiliary fuse 1224, and two battery current sensors 1220, 1222 including low/high temperature measurement. A bus bar assembly 1250 includes bus bars (e.g., seventeen in this example) for variously connecting the configuration contactor 1210, dual main contactor 1214, pyrofuse 1212, dual fast charge contactor 1216, dual utility contactor 1218, auxiliary fuse 1224, and two battery current sensors 1220, 1222, as well as terminals 1205 for interfacing with external components. The bus bar assembly 1250, and thus the terminals 1205, are tiered such that different terminals may exist in different horizontal planes of the BDU 1200. In some examples, the terminals 105 may be stacked in different planes. In the example BDU 1200, bus bars of the bus bar assembly 1250 share a surface in one plane for mounting on cooling plate via a thermally conductive pad(s) 1230. The bus bars are sunk in the bottom of the housing base 1202 to allow one-plane interface between cooling pads and cooling plate. The contactors of the BDU 1200 are perpendicular (vertical) mounted relative to the bus bar plane, while current sensors and fuses are parallel (horizontally) mounted relative to the busbar plane.

In the example of FIGS. 12A and 12B, a shared housing 1204 (e.g., plastic housing) houses the configuration contactor 1210, dual main contactor 1214, pyrofuse 1212, dual fast charge contactor 1216, dual utility contactor 1218, auxiliary fuse 1224, and two battery current sensors 1220, 1222 in an orientation to minimize the height, length, and width of the housing box, reduce material consumption, and maximize power density. The BDU 1200 may also include four NTC temperature sensors for hot spot monitoring, high voltage (HV) sensors for voltage drop monitoring, wire harnesses with HV and LV connectors to connect low voltage (LV) and HV to a battery management system. An optimized bus bar layout enables maximum power density, and bus bars are section configurable to the meet needs of different cooling strategies. The example BDU 1200 includes a dedicated bus bar slot for maximum possible creepage for clearance and electrical insulating performance. Limited and configurable mounting points enable reduced installation cost. The example BDU 1200 provides optimized thermal efficiency by including cooling pads between dual combined contactor and pyrofuse assembly and dual fast charge contactor. The complexity of BDU assembly process is reduced and simplified, and copper utilization is reduced because of the compact design.

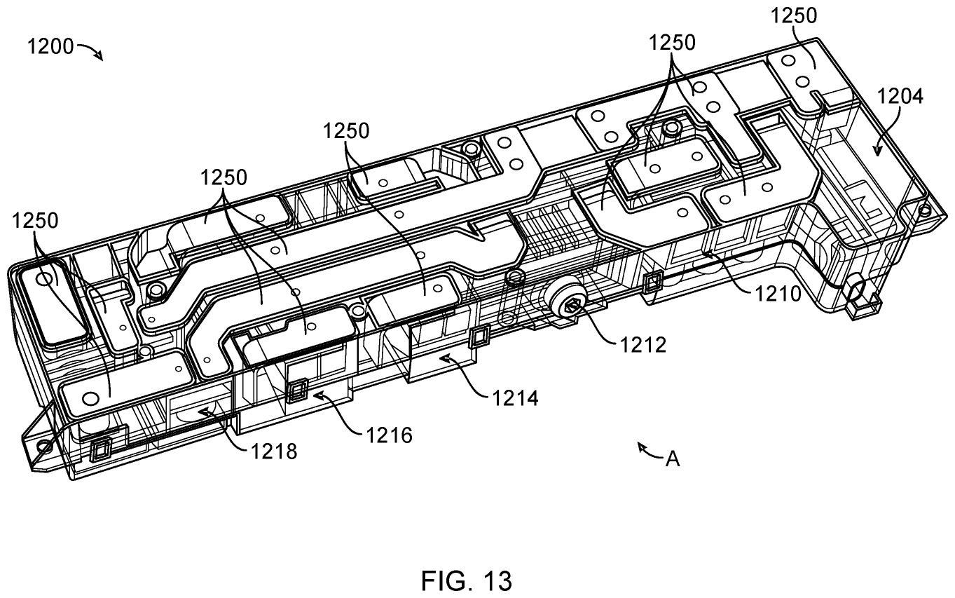

For further explanation, FIG. 13 shows a bottom view of the BDU 1200 of FIGS. 12A and 12B. The layout of the bus bar assembly 1250 is shown in FIG. 13, including the connections of the configuration contactor 1210, dual main contactor 1214, pyrofuse 1212, dual fast charge contactor 1216, and dual utility contactor 1218. The housing 1204 is shown as semitransparent for clarity. Each bus bar of the bar assembly 1250 is sunk in the housing base 1202. It can be seen that each bus bar of the bus bar assembly 1250 includes a surface in a common plane where each bus bar is seated in the housing base 1202 such that the bottom surface of each bus bar is exposed through the housing base 1202. This orientation provides a uniform surface for interfacing with a cooling plate or the thermally conductive pad 1230 in FIGS. 12A and 12B.

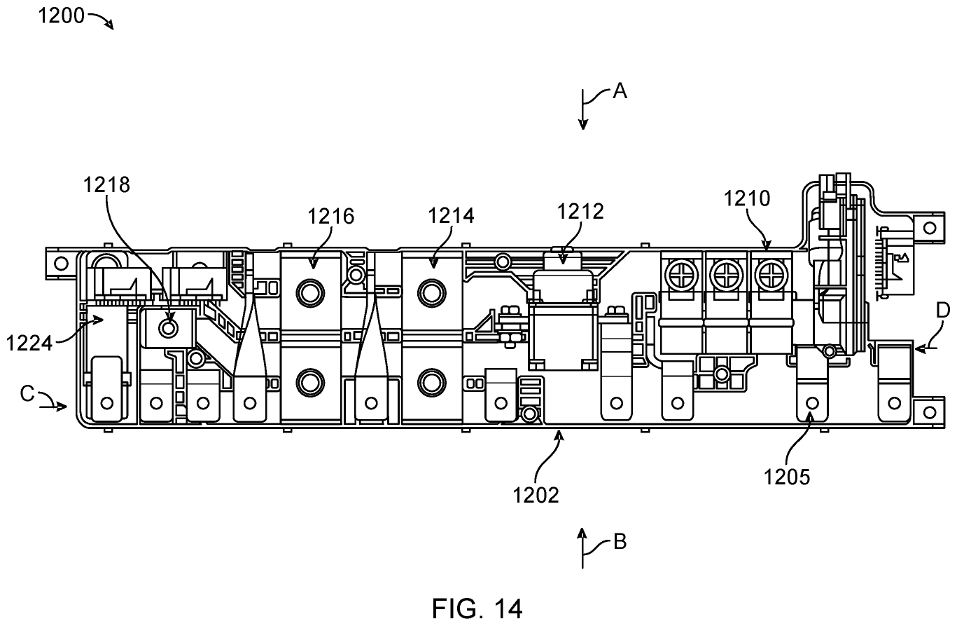

For further explanation, FIG. 14 shows a diagram of a top view of the BDU 1200 of FIGS. 12A and 12B with the housing cover 1203 removed. FIG. 14 includes the configuration contactor 1210, dual main contactor 1214, pyrofuse 1212, dual fast charge contactor 1216, dual utility contactor 1218, and auxiliary fuse 1224 seated on the housing base 1202. FIG. 14 also illustrates the layout of the terminals 1205. In addition to port side A and terminal side B, FIG. 14 also denotes lateral side C and lateral side D.

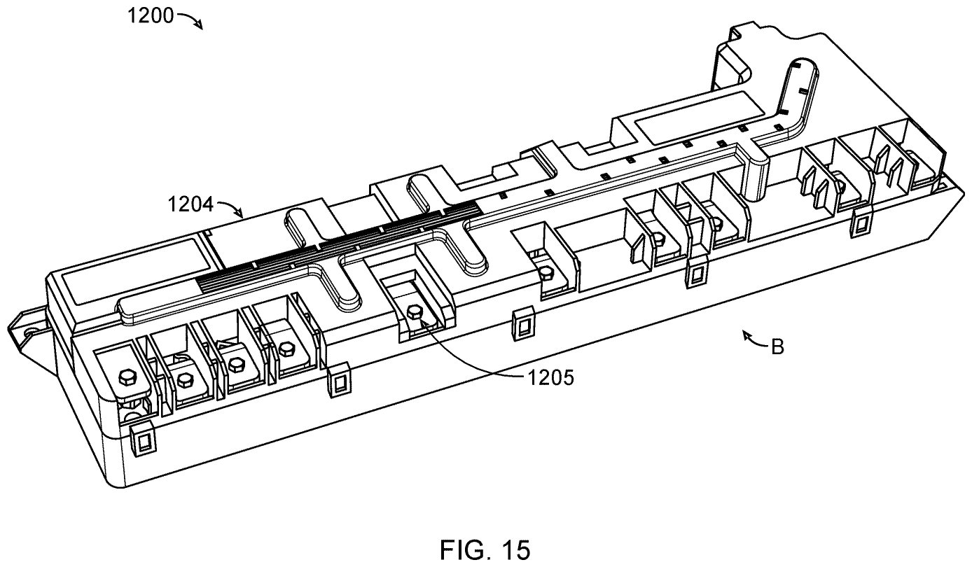

For further explanation, FIG. 15 shows a perspective view of the BDU 1200 of FIGS. 12A and 12B in an assembled state. The view of FIG. 15 shows the terminal side B. The terminals 1205 and housing 1204 are illustrated.

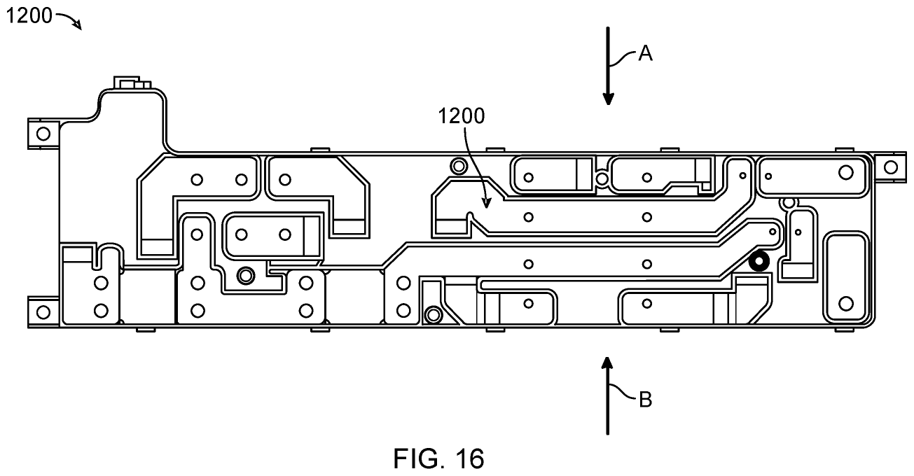

For further explanation, FIG. 16 shows a bottom plan view of the BDU 1200 of FIGS. 12A and 12B. The layout of the bus bar assembly 1250 is shown.

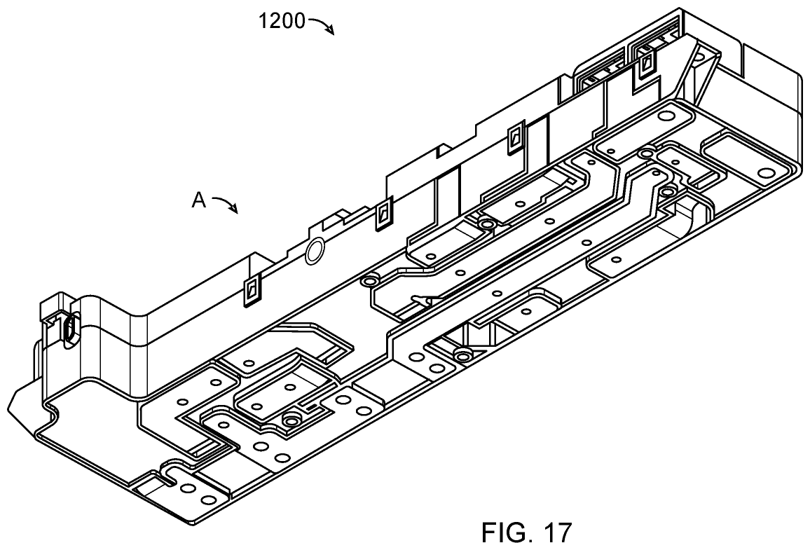

For further explanation, FIG. 17 shows a bottom perspective view of the BDU 1200 of FIGS. 12A and 12B in an assembled state.

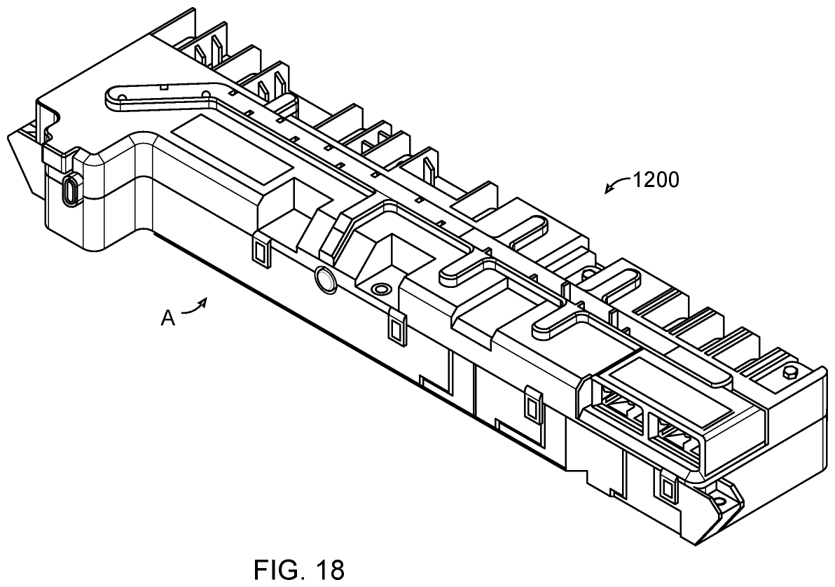

For further explanation, FIG. 18 shows a top perspective view of the BDU 1200 of FIGS. 12A and 12B in an assembled state.

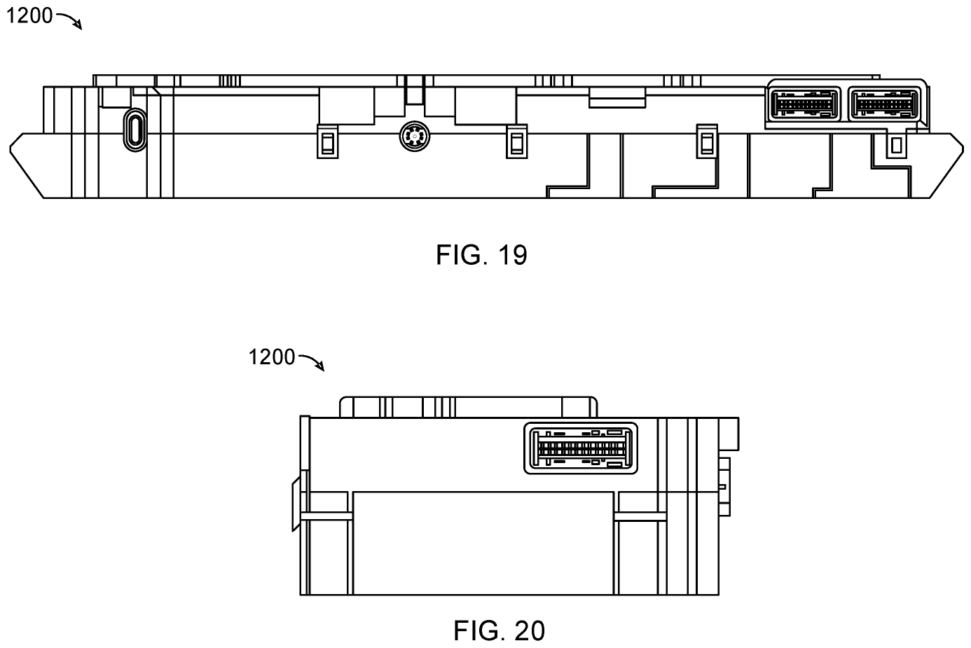

For further explanation, FIG. 19 shows a front view of the BDU 1200 of FIGS. 12A and 12B in an assembled state. The view of FIG. 19 shows the port side A.

For further explanation, FIG. 20 shows a side view of the BDU 1200 of FIGS. 12A and 12B in an assembled state. The view of FIG. 20 shows the lateral side D referenced in FIG. 14.

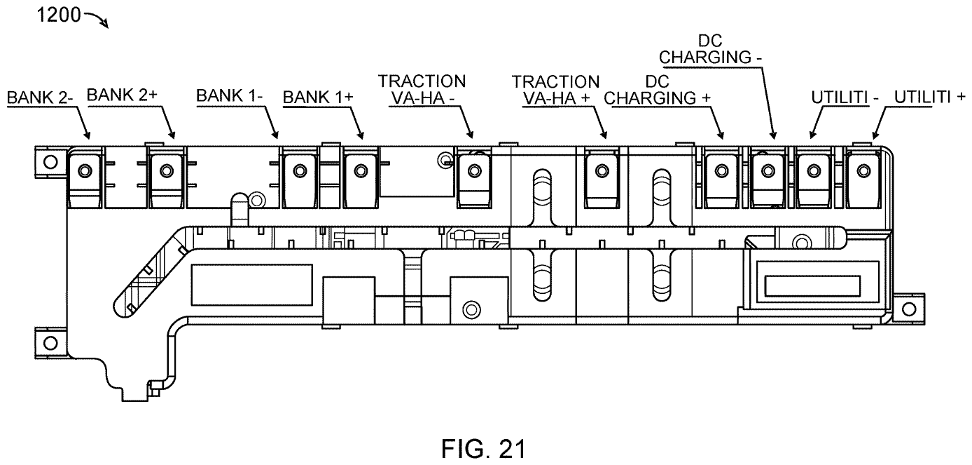

For further explanation, FIG. 21 shows an example terminal schematic of the BDU 1200 of FIGS. 12A and 12B in an assembled state. In FIG. 20, Bank 1+ and Bank 1− are positive and negative terminals of the configuration contactor 1210 that connect to a first battery pack. Bank 2+ and Bank 2− are positive and negative terminals of the configuration contactor 1210 that connect to a second battery pack. Traction VA−HA+ and Traction VA−HA− are positive and negative terminals of the dual main contactor 1214. DC Charging+ and DC Charging− are positive and negative terminals of the dual fast charge contactor 1216. Utiliti+ and Utiliti− are positive and negative terminals of the dual utility contactor 1218.

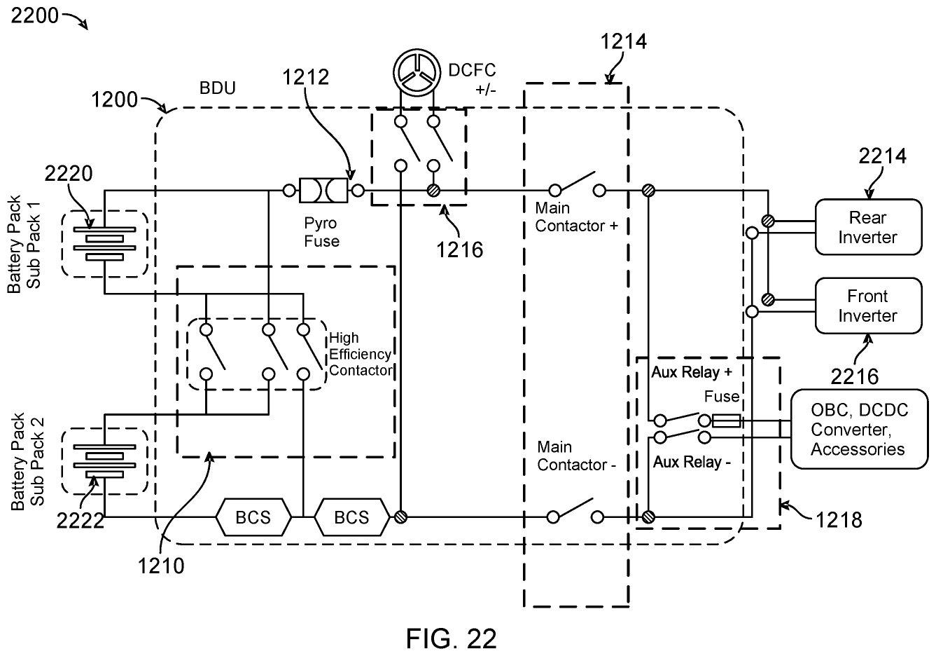

For further explanation, FIG. 22 sets forth an example electrical schematic 2200 for the example BDU 1200 of FIGS. 12A and 12B in accordance with at least one embodiment of the present disclosure. In FIG. 22, dashed boxes illustrate the switching components of the configuration contactor 1210, dual main contactor 1214, dual fast charge contactor 1216, and dual utility contactor 1218 of the BDU 1200. The BDU 1200 is connected to two battery packs 2220, 2222 through the configuration contactor. A pyrofuse 1212 is also shown. The dual main contactor 1214 connects the BDU 1200 to the front inverter 2214 and rear inverter 2216. The dual utility contactor 1218 connects the BDU 1200 to on-board charging (OBC), DC to DC converter, and other accessories.

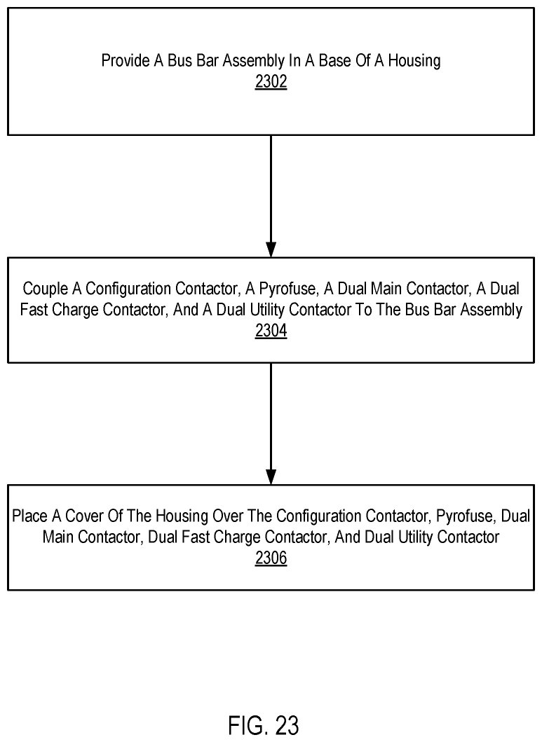

For further explanation, FIG. 23 sets forth a flowchart illustrating an example method of assembling a BDU in accordance with at least one embodiment of the present disclosure. The method of FIG. 11 includes providing 2302 a bus bar assembly in a base of a housing. For example, a bus bar assembly may be placed in a housing base as illustrated in FIGS. 12A and 12B. The method of FIG. 23 also includes coupling 2304 a configuration contactor, a pyrofuse, a dual main contactor, a dual fast charge contactor, and a dual utility contactor to the bus bar assembly. For example, the configuration contactor, pyrofuse, dual main contactor, dual fast charge contactor, and dual utility contactor may be coupled to the bus bar assembly as shown in FIGS. 12A and 12B. The method of FIG. 11 also includes placing 2306 a cover of the housing over the configuration contactor, pyrofuse, dual main contactor, dual fast charge contactor, and dual utility contactor.

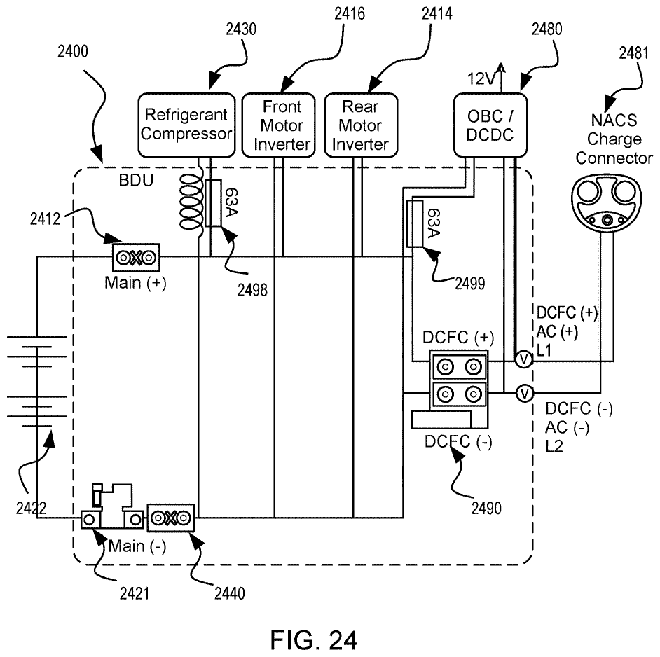

For further explanation, FIG. 24 sets forth an example electrical schematic of assembly that includes an example battery disconnect unit (BDU) 2400 according to at least one embodiment of the present disclosure. In FIG. 24, terminals of the battery packs 2422 are coupled to battery current sensor (BCS) 2421 and pyrofuses 2440, 2412 within the BDU 2400, which are coupled to the refrigerant compressor 2430, front motor inverter 2416, rear motor inverter 2414, and an on-board charging (OBC)/DC to DC converter module 2480. A dual main contactor 2490 connects the BDU 2400 to a NACS charge connector 2481 and the on-board charging (OBC)/DC to DC converter module 2480.

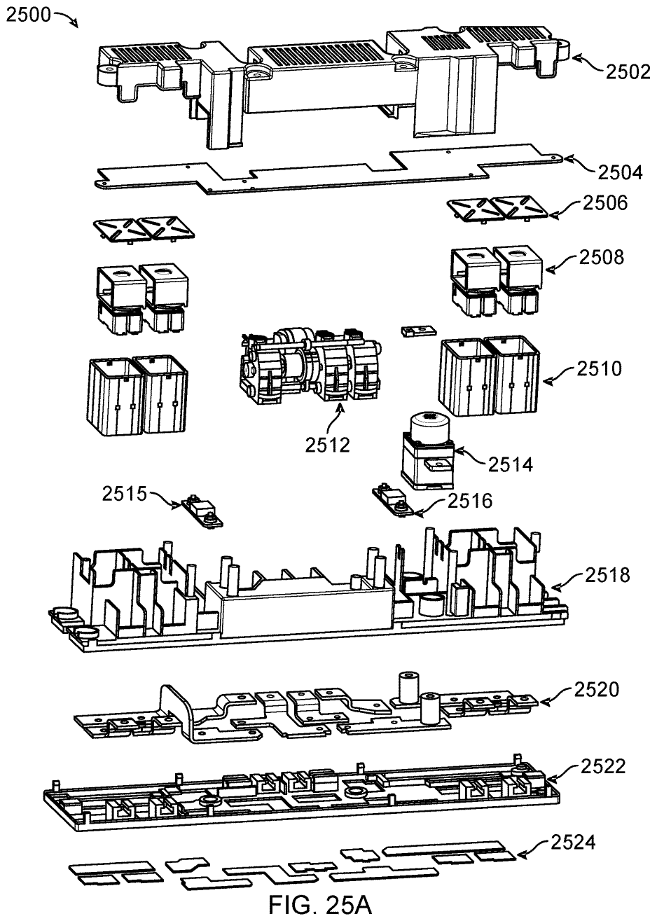

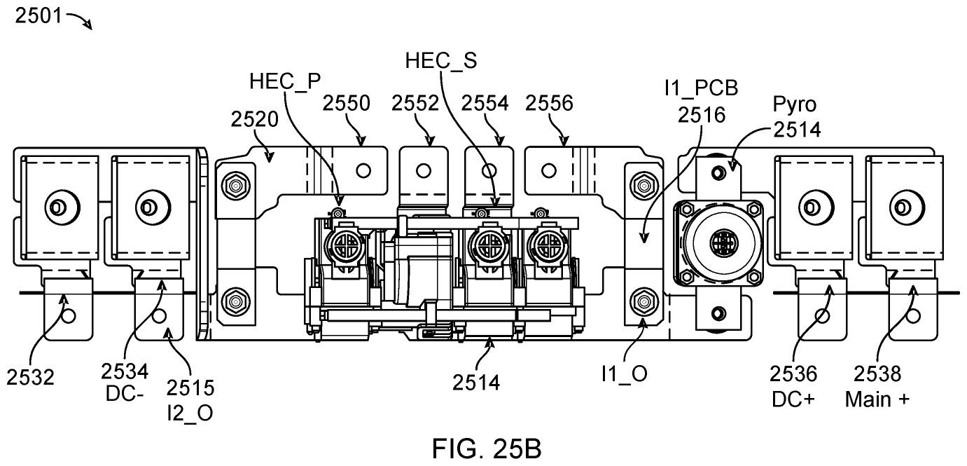

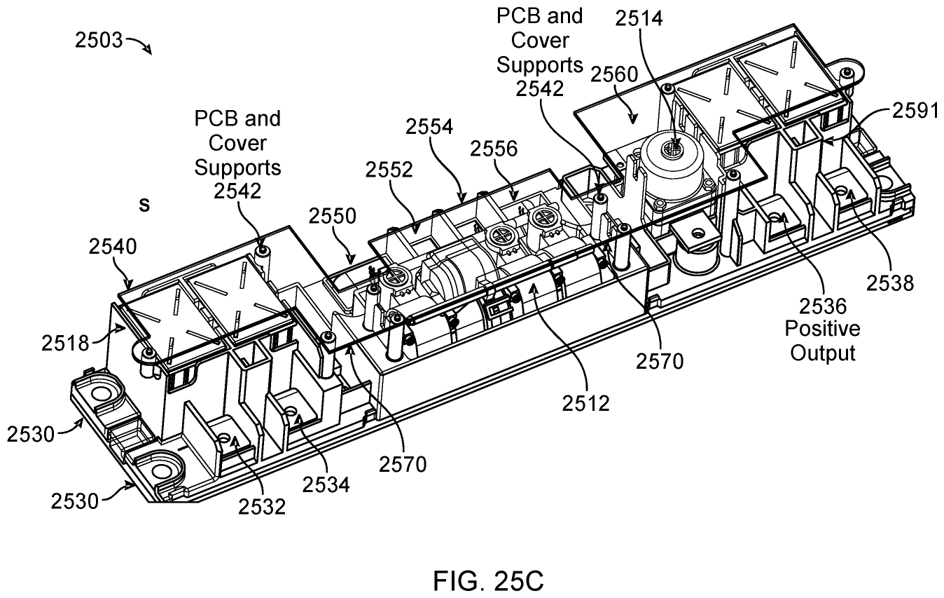

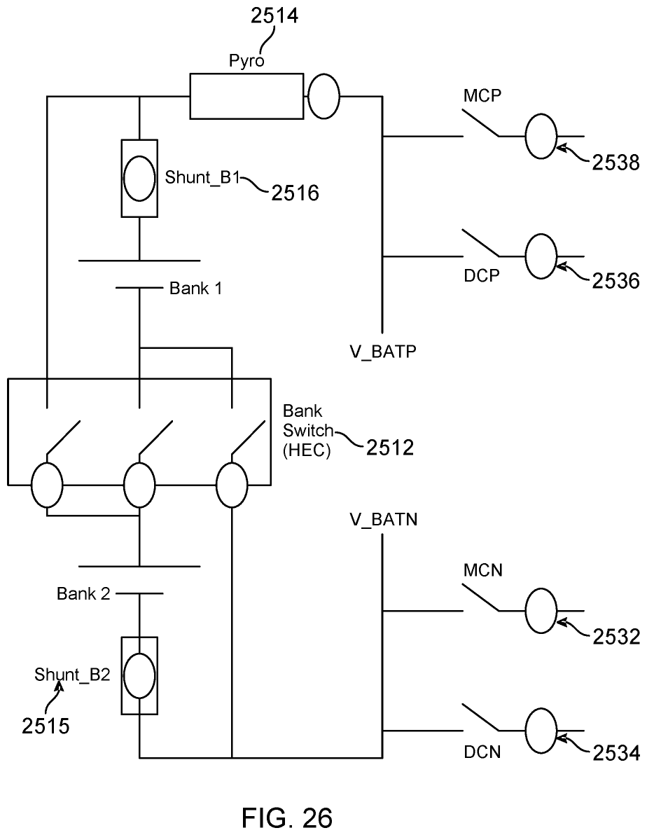

For further explanation, FIG. 25A sets forth an exploded view of another example battery disconnect unit (BDU) 2500 according to at least one embodiment of the present disclosure. The BDU 2500 includes a top cover 2502, a printed circuit board (PCB) 2504, contactor-covers 2506, uncovered contactors 2508, contactors-adaptors 2510, High-Efficiency Contactor (HEC) 2512, Pyrofuse 2514, current sensor 2516, main housing 2518, busbar assembly 2520, bottom plastic part 2522, and thermal gap filler 2524.

For further explanation, FIG. 25B sets forth an overhead view of an assembly 2501 of some of the components from the example battery disconnect unit of FIG. 25A according to at least one embodiment of the present disclosure. In the assembly 2501 of FIG. 25B, the HEC 2512 and the pyrofuse 25 are coupled to the busbar assembly 2520. A first shunt 2516 and a second shunt 2515 are also coupled to the busbar assembly 2520. Four battery connections 2550, 2552, 2554, 2556 on the busbar assembly 2520 are exposed for coupling to a set of batteries. The busbar assembly 2520 also includes a positive direct current (DC) output 2526, a positive main output 2538, a negative DC output 2534, and a second negative output 2532.

For further explanation, FIG. 25C sets forth a perspective view of an assembly 2503 of some of the components from the example battery disconnect unit (BDU) 2500 of FIG. 25A according to at least one embodiment of the present disclosure. In the assembly 2503 of FIG. 25C, a PCB placeholder 2560 is illustrated instead of the PCB 2504 of FIG. 25A. Contactor pockets 2540, mounting holes 2530, PCB and cover supports 2542, NTC feed-throughs 2591, and wiring support 2570 are also illustrated.

For further explanation, FIG. 26 sets forth an example simplified electrical schematic 2601 of an assembly of some of the components from the example battery disconnect unit (BDU) 2500 of FIG. 25A and the assembly 2501 of FIG. 25B including the HEC 2512, the pyrofuse 2514, the first shunt 2516, and the second shunt 2515. In the example of FIG. 26, the HEC 2512 as a contactor for a bank of batteries, which is coupled to the positive outputs 2538, 2536 and the negative outputs 2532, 2534 of the assembly.

In view of the foregoing, it will be recognized that combining the components in one housing reduces the size and increase power density, cooldown capabilities have been increased, and insulation properties of the components has been increased. Simplifying the design by using combine components enhances the performance of the BDU, the complexity of a BDU assembly process is reduced and simplified, and copper usage is reduced due to the compact design and optimal cooling.

The flowchart and block diagrams in the figures illustrate the architecture, functionality, and operation of possible implementations of systems, apparatuses, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Advantages and features of the present disclosure can be further described by the following statements:

1. A battery disconnect unit comprising: a housing; a configuration contactor disposed within the housing; a combined contactor and pyrofuse assembly disposed within the housing and electrically coupled to the configuration contactor; a battery charge contactor disposed within the housing and electrically coupled to the combined contactor and pyrofuse assembly; and a bus bar assembly.

2. The battery disconnect unit of statement 1, wherein the bus bar assembly is tiered.

3. The battery disconnect unit of statement 1 or 2, wherein the bus bar assembly includes terminals in one or more planes.

4. The battery disconnect unit of any of statements 1-3, wherein at least two terminals are stacked.

5. The battery disconnect unit of any of statements 1-4, wherein the bus bar assembly includes a plurality of bus bars each having a surface exposed through a bottom of the housing.

6. The battery disconnect unit of any of statements 1-5, wherein the battery disconnect unit is configurable for mounting on a cooling plate.

7. The battery disconnect unit of any of statements 1-6 further comprising one or more battery current sensors disposed within the housing.

8. A method of assembling a battery disconnect unit, the method comprising: providing a bus bar assembly in a base of a housing; coupling a configuration contactor, a dual combined contactor and pyrofuse assembly, and a dual fast charge contactor to the bus bar assembly; and placing a cover of the housing over the configuration contactor, the dual combined contactor and pyrofuse assembly, and the dual fast charge contactor.

9. The method of statement 8, wherein the base includes a plurality of apertures; wherein the bus bar assembly includes a plurality of bus bars; and wherein each bus bar is seated in a respective aperture.

10. The method of statement 8 or 9, wherein the bus bar assembly is tiered.

11. The method of any of statements 8-10, wherein the bus bar assembly includes terminals in one or more planes.

12. The method of any of statements 8-11, wherein at least two terminals are stacked.

13. The method of any of statements 8-12, wherein the battery disconnect unit is configurable for mounting on a cooling plate.

14. A battery disconnect unit comprising: a housing; a configuration contactor disposed within the housing; a pyrofuse disposed within the housing and electrically coupled to the configuration contactor; a dual main contactor disposed within the housing and electrically coupled to the pyrofuse; a dual fast charge contactor disposed within the housing and electrically coupled to the dual main contactor; a dual utility contactor; and a bus bar assembly coupled to the configuration contactor, pyrofuse, dual main contactor, dual fast charge contactor, and dual utility contactor.

15. The battery disconnect unit of statement 14 further comprising a thermally conductive pad disposed on a bottom surface of the housing.

16. The battery disconnect unit of statement 14 or 15, wherein the bus bar assembly includes a plurality of bus bars each having a surface exposed through a bottom surface of the housing.

17. The battery disconnect unit of any of statements 14-16 further comprising one or more battery sensors.

18. A method of assembling a battery disconnect unit comprising: providing a bus bar assembly in a base of a housing; coupling a configuration contactor, a pyrofuse, a dual main contactor, a dual fast charge contactor, and a dual utility contactor to the bus bar assembly; and placing a cover of the housing over the configuration contactor, pyrofuse, dual main contactor, dual fast charge contactor, and dual utility contactor.

19. The method of statement 18 further comprising placing a thermally conductive pad on a bottom surface of the housing.

20. The method of statement 18 or 19, wherein the bus bar assembly includes a plurality of bus bars each having a surface exposed through a bottom surface of the housing.

21. The method of any of statements 18-20, wherein further comprising installing one or more battery current sensors.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A battery disconnect unit comprising:
a housing;
a configuration contactor disposed within the housing;
a combined contactor and pyrofuse assembly disposed within the housing and electrically coupled to the configuration contactor;
a battery charge contactor disposed within the housing and electrically coupled to the combined contactor and pyrofuse assembly; and
a bus bar assembly.

2. The battery disconnect unit of claim 1, wherein the bus bar assembly is tiered.

3. The battery disconnect unit of claim 2, wherein the bus bar assembly includes terminals in one or more planes.

4. The battery disconnect unit of claim 3, wherein at least two terminals are stacked.

5. The battery disconnect unit of claim 1, wherein the bus bar assembly includes a plurality of bus bars each having a surface exposed through a bottom of the housing.

6. The battery disconnect unit of claim 5, wherein the battery disconnect unit is configurable for mounting on a cooling plate.

7. The battery disconnect unit of claim 1 further comprising one or more battery current sensors disposed within the housing.

8. A method of assembling a battery disconnect unit, the method comprising:
providing a bus bar assembly in a base of a housing;
coupling a configuration contactor, a dual combined contactor and pyrofuse assembly, and a dual fast charge contactor to the bus bar assembly; and
placing a cover of the housing over the configuration contactor, the dual combined contactor and pyrofuse assembly, and the dual fast charge contactor.

9. The method of claim 8, wherein the base includes a plurality of apertures; wherein the bus bar assembly includes a plurality of bus bars; and wherein each bus bar is seated in a respective aperture.

10. The method of claim 8, wherein the bus bar assembly is tiered.

11. The method of claim 10, wherein the bus bar assembly includes terminals in one or more planes.

12. The method of claim 11, wherein at least two terminals are stacked.

13. The method of claim 8, wherein the battery disconnect unit is configurable for mounting on a cooling plate.

14. A battery disconnect unit comprising:
a housing;
a configuration contactor disposed within the housing;
a pyrofuse disposed within the housing and electrically coupled to the configuration contactor;
a dual main contactor disposed within the housing and electrically coupled to the pyrofuse;
a dual fast charge contactor disposed within the housing and electrically coupled to the dual main contactor;
a dual utility contactor; and
a bus bar assembly coupled to the configuration contactor, pyrofuse, dual main contactor, dual fast charge contactor, and dual utility contactor.

15. The battery disconnect unit of claim 14 further comprising a thermally conductive pad disposed on a bottom surface of the housing.

16. The battery disconnect unit of claim 14, wherein the bus bar assembly includes a plurality of bus bars each having a surface exposed through a bottom surface of the housing.

17. The battery disconnect unit of claim 14 further comprising one or more battery sensors.

18. A method of assembling a battery disconnect unit comprising:
providing a bus bar assembly in a base of a housing;
coupling a configuration contactor, a pyrofuse, a dual main contactor, a dual fast charge contactor, and a dual utility contactor to the bus bar assembly; and
placing a cover of the housing over the configuration contactor, pyrofuse, dual main contactor, dual fast charge contactor, and dual utility contactor.

19. The method of claim 18 further comprising placing a thermally conductive pad on a bottom surface of the housing.

20. The method of claim 18, wherein the bus bar assembly includes a plurality of bus bars each having a surface exposed through a bottom surface of the housing.

21. The method of claim 18, wherein further comprising installing one or more battery current sensors.
